(19) United States
(12) Patent Application Publication
(10) Pub. No.: US 2002/0092014 A1
(43) Pub. Date: Jul. 11, 2002

(54) Software installing method and system

(76) Inventors: Yasuo Shibusawa, Nagano (JP); Yoichi Nishimura, Nagano (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/004,825

(22) Filed: Dec. 7, 2001

(30) Foreign Application Priority Data
Dec. 8, 2000 (JP) 2000-374604
Dec. 6, 2001 (JP) 2001-373292

(51) Int. Cl. G06F 9/445

(52) U.S. Cl. 717/174

(57) ABSTRACT

An installation method and system for installing software onto a computer system. A vendor's computer system manages system configuration of each computer system sold to users. A user's computer system, on which software is going to be installed, sends its identification information to the vendor's computer system. In response, the vendor's computer system recognizes the system configuration of the user's computer system from the sent identification information and sends software corresponding to that system configuration. Further, even if the computer systems have different system configurations, the initial configurations of the respective system configurations can be easily recovered.

### BACKGROUND OF THE INVENTION

1. Field of the Invention

The present invention relates to a method of installing software onto a computer system and a system for implementing such method. More particularly, this invention relates to a method of installing new software onto the computer system having certain software already installed thereon and recovering the initial configuration of the computer system, and a system for implementing such method.

2. Description of the Related Art

A computer system, typified by a personal computer, comprises hardware elements such as a main system, a display, and various peripherals as well as software (program) elements such as an operating system (OS; basic program), device drivers, and application programs.

At the time of the initial introduction of the computer system, a consumer (user) needs to set up both the hardware and the software of the computer system, which is in the initial configuration of the factory-default setting. Upon the setup of the software, the user installs necessary software such as device drivers from a storage medium such as a CD-ROM onto the system, thereby conducting the environment settings. For the sake of simplifying such user's task, in recent years, the setup is automatically conducted by having a setup program, which is installed onto the system in advance, detect its system configuration and install the necessary software onto the computer system.

When a problem occurs for some reason with any software element of the computer system after the user started to use the computer system, re-setup is sometimes conducted regarding the software, including the OS. In this case, the user installs onto the system the content stored in a storage medium called “recovery CD” which accompanies the computer system, thereby recovering the initial configuration of the computer system.

A business method so-called BTO (Built to Order) scheme is known in which an order for a product is received from a user and a product is custom manufactured. In the computer business, for example, a user makes an order specifying the configuration of the hardware elements (system configuration) such as CPU, a memory, and a hard disk. A vendor builds components, manufactures a computer system to order in a factory, and sells it to the user. In this case, software such as device drivers which should be installed in the system is determined, to suit the system configuration.

Accordingly, since the computer systems manufactured in the BTO scheme have different system configurations, when a problem occurs with a software element for some reason and the initial configuration of the factory-default settings of the computer systems needs to be recovered, the recovery can not be completed only by using the recovery CD. Instead, the user has to install other software with regard to the system configuration parts that are peculiar to the user.

### SUMMARY OF THE INVENTION

An object of the present invention is to provide, for the computer systems having different system configurations, a method of recovering the initial state of each system configuration and a system for implementing such method, and consequently applying this method to software installation.

The gist of this invention is as follows: a computer system at a vendor manages system configuration of an individual computer system sold to a user; the user's computer system, on which software (program and/or data) is going to be installed, sends its identification information to the computer system at the vendor; as a response to the transmission, the computer system at the vendor identifies the system configuration of the user's computer system with reference to the identification information, and sends a corresponding software to the user's computer system. Thereby, computer systems of different system configurations can easily have the software necessary for the respective system configurations installed.

Briefly, this invention provides a software installation method comprising the steps of: storing information related to a constituent element of a computer system and software required for the constituent element, which correspond to each other, and also storing identification information for identifying a computer system, which is configured by a specified constituent element and supplied to a user, and system configuration information indicating that the computer system configured by the specific constituent element, which correspond to each other; accepting from the user's computer system the identification information given to the user's computer system; and sending, to the user's computer system, software required for the specific constituent element of the user's computer system, on the basis of the system configuration information which corresponds to the accepted identification information.

In this invention, the software installation method may further comprise the steps of: managing, for an individual user, a fee for the software sent to the user's computer system; and collecting the fee from the user. According to this invention, a software fee can be managed for an individual computer system, that is, for every user owning a computer system. Thereby, billing can be easily conducted for the user regarding the price (fee) for software sent to the user's computer system. Particularly, in this invention, software to be sent differs depending on the configuration elements of the computer systems. Therefore, detailed billing can be conducted on the basis of the system environments of the users by managing the respective computer systems concerning which software was sent to which computer system.

Moreover, this invention provides a software installation method comprising: a first database for storing information related to a constituent element of a computer system and software required for the constituent element, which correspond to each other; a second database for storing identification information for identifying a computer system which is configured by a specified constituent element and supplied to a user, and system configuration information indicating that the computer system configured by the specific constituent element, which correspond to each other; an accepting means for accepting from the user's computer system the identification information given to the user's computer system; first detecting means for detecting system configuration information which corresponds to the accepted identification information, with reference to the second database; second detecting means for detecting software required for the specific constituent element which is indicated in the system configuration information, with reference to the first database; and sending means for sending the detected software to the user's computer system.

Furthermore, this invention provides a storage medium having software stored thereon for making a computer system, which has a memory in which identification information is stored, execute a function of installing a specified software onto the computer system, wherein, the software comprises the functions of: sending the identification information to another computer system; accepting, in response to the above function, software sent from the other computer system; and conducting specified setup processing in order to make the accepted software into an executable state.

Examples of the storage medium include hard disks (HDs), DVD-RAMs, flexible disks (FDs), CD-ROMs, as well as solid memories such as RAMs and ROMs. Examples of the computer system include so-called microcomputers, in which so-called central processing units such as CPU and MPU interpret a program and thereby conduct specified processing.

This invention may be implemented as an installation system in which a client/server system, which is configured by a first computer system and a second computer system, installs software onto the first computer system.

The term “means” used in this specification does not simply refer to hardware. There are cases in which functions of means are implemented by software. Moreover, a function of one means may be realized by two or more pieces of hardware, and functions of two or more means may be realized by one piece of hardware.

### BRIEF DESCRIPTION OF THE DRAWINGS

FIG. 1 is a drawing illustrative of the entire system for implementing the installation method according to one embodiment of this invention.

FIG. 2 illustrates a sample data structure of the system configuration database according to one embodiment of this invention.

FIG. 3 illustrates a sample data structure of the hardware/software management database according to one embodiment of this invention.

FIG. 4 illustrates a sample database reference screen according to one embodiment of this invention.

FIG. 5 is a flow chart illustrative of the processing procedure of the installation method according to one embodiment of this invention.

FIG. 6 is a flow chart illustrative of the operations of the server system in the download/installation processing.

### DESCRIPTION OF THE PREFERRED EMBODIMENTS

A preferred embodiment of this invention is hereinafter explained in detail with reference to the attached drawings. This embodiment is an example illustrating this invention and this invention is not limited to this embodiment only. This invention may be implemented in various embodiments as long as the implementation does not deviate from the gist of this invention.

Explanation of the following embodiment is predicated on a business method called Built to Order (BTO) scheme, in which an order of a computer product is received from a user and the computer product is custom manufactured and is sold to the user. Specifically, the user makes an order by specifying a CPU, a memory, a hard disk, as well as application software to be preinstalled, while a vendor assembles components in a factory on the basis of the order, completes a custom computer system as a product, and sells it to the user.

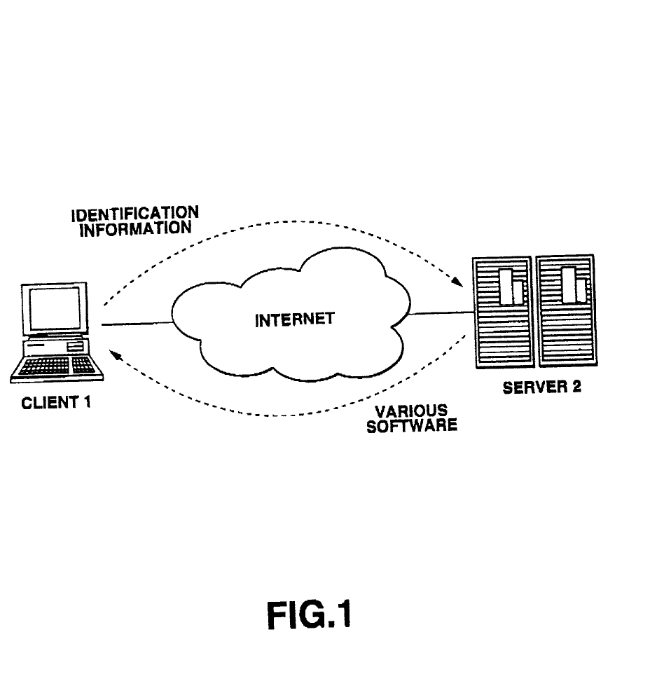

FIG. 1 is a drawing illustrative of the entire system for implementing the installation method according to this embodiment. This entire system is constituted as a client/server system in which a client and a server are connected via the Internet.

A client system 1 is a computer system purchased by a user from a vendor in the BTO scheme. This client system 1 is configured by several specified hardware elements and has several software elements integrated therein that corresponds to the hardware elements.

The hardware elements constituting the client system 1 includes a main system including a mother board (sometimes called “system board”) mainly constituted of a CPU, and peripherals such as a display, a keyboard, a hard disk, and a printer. On the other hand, the software elements integrated into the client system 1 include an operating system, various device drivers, and various application software. Typically, the operating system and the various device drivers depend on the hardware elements constituting the client system 1, and the various application software are what the user selects as appropriate from the application software which depends on the operating system.

In this embodiment, the client system 1 has a nonvolatile memory such as a ROM on the mother board having BIOS stored thereon. On this nonvolatile memory, unique identification information (product ID) for identifying an individual computer system is stored. Accordingly, the vendor writes such product ID on the ROM when building a computer system on the basis of the order made by the user.

A server system 2 is a computer system operated by the vendor and comprises various databases (not shown in the drawings). Examples of the databases the server system 2 comprises include a client database, an order database, a system configuration database, and a hardware/software management database (hereinafter referred to as “H/S management database”) Each record in these databases is constituted by relating to each other.

The client database manages, for every user ID, the information of the users who made orders, specifically, the information about the users' names, addresses, telephone numbers, as well as the information about the users' computer systems updates. The information about the update of the software of the users' computer systems is the information about when the users update their computer systems by installing software with the software installation system of this invention, and which software the users installed, as well as the fees (prices) required for installing the software. Moreover, the order database manages user IDs and product IDs for every order ID.

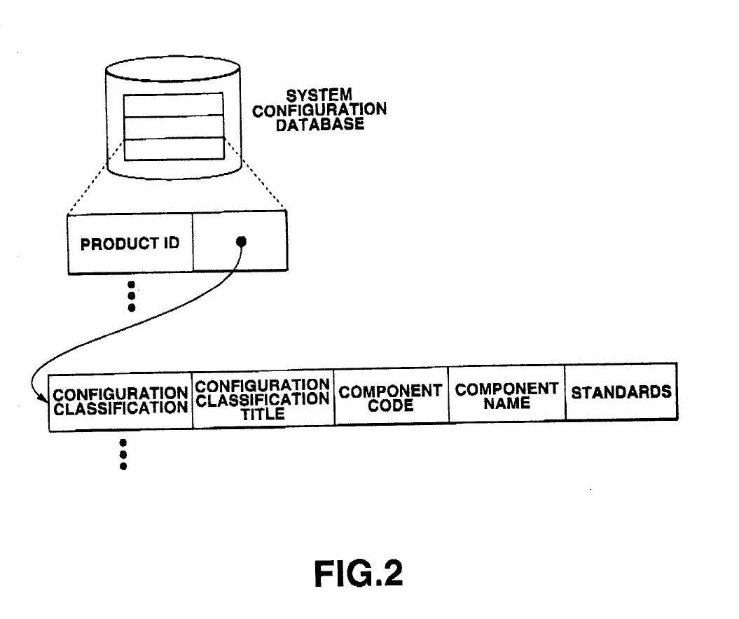

The system configuration database manages, for every product ID, the hardware elements constituting each computer system. FIG. 2 illustrates a sample data structure of the system configuration database according to this embodiment. As shown in FIG. 2, the system configuration database establishes correspondence between the product IDs and the system configuration tables by using the pointer. The system configuration table includes every field of, for example, configuration classification data, configuration classification title data, component code data, component name data, and standards data. The component code data is for distinguishing the respective hardware elements.

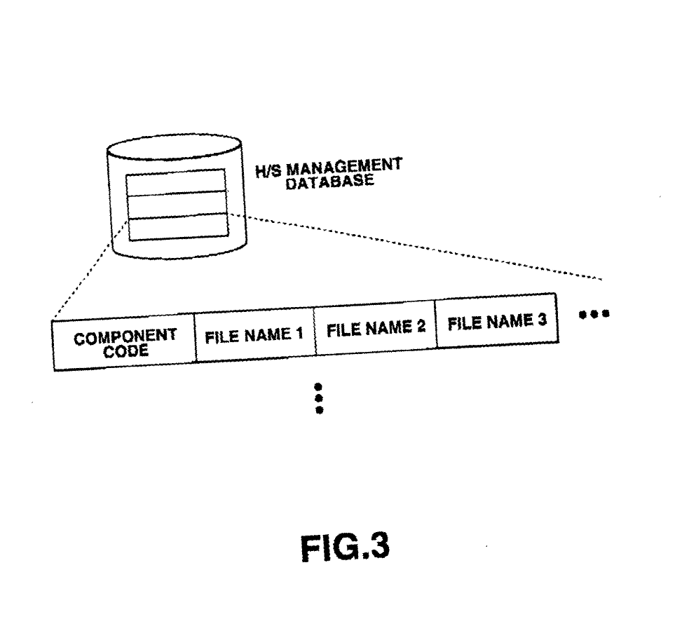

The H/S management database respectively manages the software elements required for the hardware elements. FIG. 3 shows a sample data structure of the H/S management database according to this embodiment. As shown in FIG. 3, the H/S management database manages file names of the software elements required for the hardware elements. The term “software elements” used herein refers to, for example, an operating system for the main system, various device drivers, and various application software. Moreover, if the hardware elements require a plurality of software elements, a plurality of file names are registered respectively.

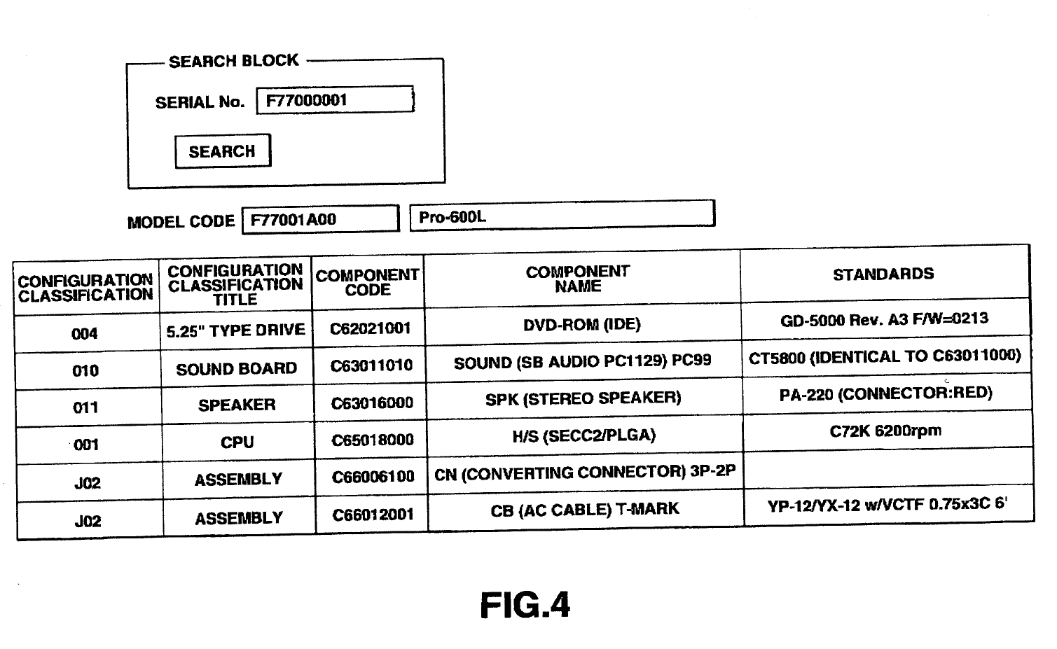

The vendor operating the server system 2 can refer as appropriate to the data registered in the database by using a computer terminal at hand. FIG. 4 illustrates a sample reference screen of a system configuration of a certain computer system. As shown in FIG. 4, the vendor inputs a serial number (i.e. product ID) into an input field and refers to a system configuration list for the computer system of the inputted product ID.

Return to FIG. 1. In this system structured as above, the installation method is conducted in the following processing procedure. Specifically, when a problem occurs for some reason to the software elements such as the operating system, the client system 1 executes recovery software which is read from a boot FD. The reason for executing the recovery software by reading it from the boot FD is that a FD device is, in many cases, designated as a primary boot device at a BIOS level. However, if, for example, a CD-ROM device can be designated as the primary boot device at the BIOS level, the recovery software may be executed by reading it from a recovery CD, without using the boot FD. The client system for executing the recovery software, reads the software as appropriate from the recovery CD and reconstructs the software elements from the low BIOS level, thereby recovering the function of the computer system. In this case, the client systems 1 made in the BTO scheme differ in their system configurations among the respective users; therefore, with some recovery CDs, it is extremely difficult to support all the software elements. Accordingly, regarding the non-supported software elements, the client system 1 sends to the server system 2 the identification information (product ID) stored in the client system 1 itself, downloads the software elements from the server system 2 in response, and conducts the installation processing (setup processing). The term “installation processing” used herein includes the process of storing the software elements as files in a file system of the client system 1 as well as the related process of generating and constructing the system information which the operating system manages, and setting up the system information in an executable configuration.

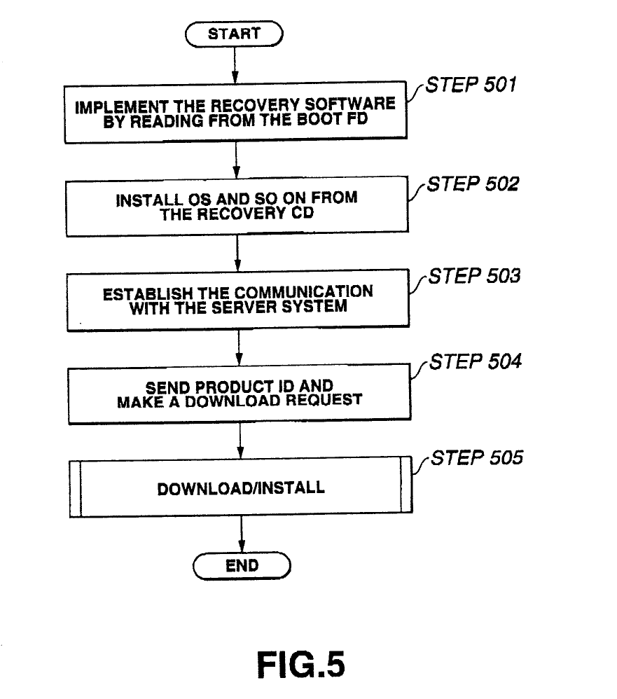

FIG. 5 is a flow chart illustrative of the processing procedure of the installation method according to this embodiment. The processing procedure is shown in sequence; however, the processing procedure is not limited to such sequentiality. Accordingly, as long as there is no inconsistency in the operations, the sequence of the processing may be changed or the processing may be conducted in a parallel sequence.

If a problem concerning the software occurs in the client system 1 used by a user, the user inserts the boot FD into the FD device of the client system 1 and turns on the power of the main system. Thereby, the client system 1 automatically reads the recovery software from the boot FD, and executes the recovery software (STEP 501). The client system 1 conducts as follows the installation processing as the recovery software is executed.

Specifically, in the execution of the recovery software, the client system 1 prompts the user to insert the recovery CD into the CD device, and the user does so. The client system 1 installs the software elements such as the operating system from the inserted recovery CD (STEP 502). Stored on the recovery CD is preferably the software elements necessary for those system configurations common to the users among the system configurations of the client system 1. Or, more preferably, stored on the recovery CD is a communication driver for establishing communication between the client system 1 and the server system 2 via the network as well as download software specifying a certain downloading protocol. In the execution of the recovery software, the client system 1 installs the communication driver, transfers its execution control to the download software, and establishes communication with the server system 2 (STEP 503).

Once communication is established between the client system 1 and the server system 2, the client system 1 reads the product ID from the ROM and sends a download request including the product ID to the server system 2 (STEP 504). Thereby, downloading and installing are started between the client system 1 and the server system 2 (STEP 505) and the installation processing is completed when the installation of all the software elements onto the client system 1 is completed.

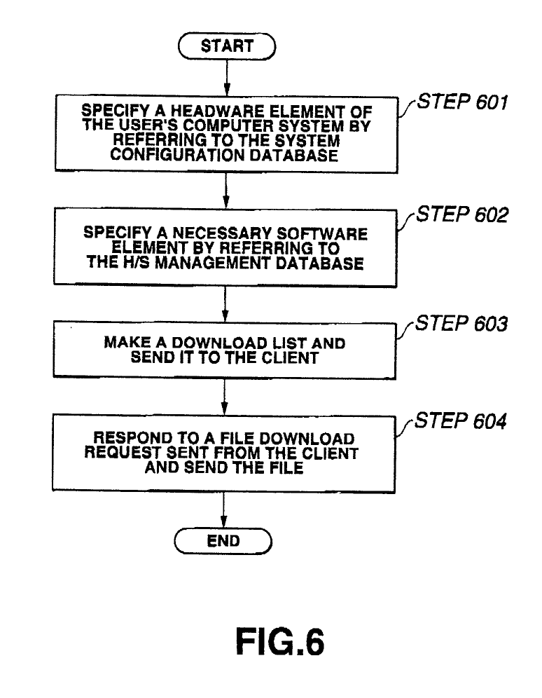

FIG. 6 is a flow chart illustrative of the operation of the server system 2 in the download/installation processing. When the server system 2 accepts a download request from the client system 1, it retrieves the product ID, refers to the system configuration database, and specifies the system configuration, that is, the hardware elements of the client system 1 (STEP 601). Next, the server system 2 refers to the H/S management database and specifies each software element required for the respective specified hardware elements (STEP 602). The server system 2 makes a download list which the client system 1 should require on the basis of the specified software elements, and sends the download list to the client system 1 (STEP 503). The client system 1 receives the download list and requires the server system 2 to download the respective software elements in accordance with the download list. Specifically, the server system 2 responds to the download request of the respective software elements, this request being sent from the client system 1, and sends the software elements (files) to the client system 1 (STEP 504).

As explained above, in this embodiment, the initial configuration of the computer system can be easily recovered even if, for some reason, a software problem occurs with the computer system. Particularly, in this embodiment, regarding the computer systems having different system configurations for different users due to the BTO scheme, the initial configurations of the computer systems can be easily recovered.

The above embodiment is an example for explaining this invention and it is not intended to limit this invention to this embodiment only. This invention may be implemented in various embodiments as long as the implementation does not deviate from the gist of this invention.

In the above embodiment, the software elements required for the system configuration parts common to the users are installed from the boot FD. However, such software elements may be installed by downloading from the server system 2. The software elements may also be stored in the ROM with the BIOS, instead of being read from the boot FD. In this case, the implementation of the recovery software may be conducted by pressing special keys (ESC +F1) that are previously determined when the computer is turned on or when the computer system is rebooted.

Moreover, in this embodiment, the system configuration of the client system 1 is managed at the server system 2. However, the client system 1 may collect its system configuration information by implementing the self-diagnostic software, and then sending the information to the server system 2. Thereby, the server system 2 can recognize the hardware elements the user added after the purchase and delivery of the computer system, and the server system 2 can download and install the software elements necessary for the added hardware elements. The server system 2 can manage the latest system configuration information sent from the client system 1.

Furthermore, in this embodiment, it may be arranged that the fees for the software sent to the computer systems of the users are managed for every user and the fees are collected from the users. Thereby, it becomes possible to charge the users the prices (fees) corresponding to the software sent. Particularly, software to be sent differs based on the configuration elements of the computer systems; therefore, detailed billing on the basis of the system environments of the users can be conducted by managing the respective computer systems concerning which software was sent to which computer system.

And yet, in this embodiment, it may be arranged that the client system 1 is constituted by a plurality of computer systems connected to each other via the LAN and that these computer systems are implemented as appropriate by making them work together. In short, in the execution of the recovery software, a computer system which is a subject of reinstallation, may download the software elements into the file system of other computer systems and then install the software elements onto the computer system itself.

Recovering the initial configurations of the computer systems does not mean recovering the previous versions of the software elements. Accordingly, the software element of the latest version may be downloaded and installed from the server system 2. Thereby, this invention can be applied not only for recovering the initial configuration of the computer system when a problem occurs, but also for updating the version of the software. Moreover, it is possible to configure the software which should be downloaded as difference software so that an update may be conducted by making a patch of the additional software to the software that was already installed from the recovery CD.

As explained above, according to this invention, the computer systems having different system configurations can be installed with software suitable for their respective system configurations. Accordingly, the user's responsibility of installing operations is lightened and the user can, without fail, obtain software necessary for recovering the initial configuration of his/her computer system. On the other hand, the vendor can, without fail, provide necessary software to the user and ascertain the system configuration of the user's computer system.

What is claimed is:

1. A software installation method comprising the steps of:
storing information related to a constituent element of a computer system and software required for the constituent element, which correspond to each other, and also storing identification information for identifying a computer system, which is configured by a specified constituent element and supplied to a user, and system configuration information indicating that the computer system configured by the specific constituent element, which correspond to each other;
accepting from the user's computer system the identification information given to the user's computer system; and
sending, to the user's computer system, software required for the specific constituent element of the user's computer system, on the basis of the system configuration information which corresponds to the accepted identification information.

2. The software installation method according to claim 1, further comprising the steps of:
managing, for an individual user, a fee for the software sent to the user's computer system; and
collecting the fee from the user.

3. A software installation method comprising:
a first database for storing information related to a constituent element of a computer system and software required for the constituent element, which correspond to each other;
a second database for storing identification information for identifying a computer system which is configured by a specified constituent element and supplied to a user, and system configuration information indicating that the computer system configured by the specific constituent element, which correspond to each other;
an accepting means for accepting from the user's computer system the identification information given to the user's computer system;
first detecting means for detecting system configuration information which corresponds to the accepted identification information, with reference to the second database;
second detecting means for detecting software required for the specific constituent element which is indicated in the system configuration information, with reference to the first database; and
sending means for sending the detected software to the user's computer system.

4. A software installation method comprising the steps of:
sending identification information given to a first computer system to a second computer system;
accepting, in response to the above step, software required for a specific constituent element, which is indicated in system configuration information which corresponds to the identification information sent from the second computer system; and
conducting specified setup processing in order to make the software accepted in the accepting step into an executable state.

5. The software installation method according to claim 4, wherein the first computer system reads and executes a specified installation software which is stored in a specified storage medium.

6. The software installation method according to claim 5, further comprising the step of storing software which the first computer system receives from the second computer system.

7. A storage medium having software stored thereon for making a computer system, which has a memory in which identification information is stored, execute the function of installing a specified software onto the computer system, wherein,
the software comprises the functions of:
sending the identification information to another computer system;
accepting, in response to the above function, software sent from the other computer system; and
conducting specified setup processing in order to make the accepted software into an executable state.

8. An installation system for a client/server system constituted by a first computer system and a second computer system, by which software is installed onto the first computer system,
wherein the first computer system comprises:
means for storing identification information for identifying an individual computer system;
means for connecting the first computer system itself to the second computer system and sending the identification information to the second computer system, in accordance with an recovery instruction given from a user; and
first accepting means for accepting software sent from the second computer system, and
wherein the second computer system comprises:
a first database for storing information related to a constituent element of the first computer system and software required for the constituent element, which correspond to each other;
a second database for storing identification information for identifying a computer system which is configured by a specified constituent element and supplied to a user, and system configuration information indicating that the computer system configured by the specific constituent element, which correspond to each other;
second accepting means for accepting, from the user's computer system, the identification information given to the user's computer system;
accepting means for accepting the identification information sent from the first computer system;
first detecting means for detecting system configuration information which corresponds to the accepted identification information, with reference to the second database;
second detecting means for detecting software required for the specific constituent element which is indicated in the system configuration information, with reference to the first database; and
sending means for sending the detected software to the first computer system.
